(19) United States
(12) Patent Application Publication
(10) Pub. No.: US 2016/0003668 A1
(43) Pub. Date: Jan. 7, 2016

(54) MONITORING DEVICE

(71) Applicants: Ian Newby, Rotherham (GB); Stephen Mottershead, Rotherham (GB)

(72) Inventors: Ian Newby, Rotherham (GB); Stephen Mottershead, Rotherham (GB)

(73) Assignee: AES ENGINEERING LTD., Rotherham (GB)

(21) Appl. No.: 14/792,428

(22) Filed: Jul. 6, 2015

(30) Foreign Application Priority Data
Jul. 4, 2014 (GB) 1411995.2

(51) Int. Cl. G01H 1/00; G01K 13/00

(52) U.S. Cl. CPC G01H 1/003; G01K 13/00

(57) ABSTRACT

A condition monitor device monitors at least one of vibration and temperature of a piece of equipment, the condition monitor device preferably includes an enclosure within which is located at least one vibration sensor and at least one temperature sensor. A processor is located in the enclosure and is connected to at least one of the sensors for analyzing signals produced therefrom. A storage device is located in the enclosure for storing of the analyzed signals. The monitor may be mounted on the piece of equipment and the condition monitor is able to be connected, either wireless or wired, to a secondary device.

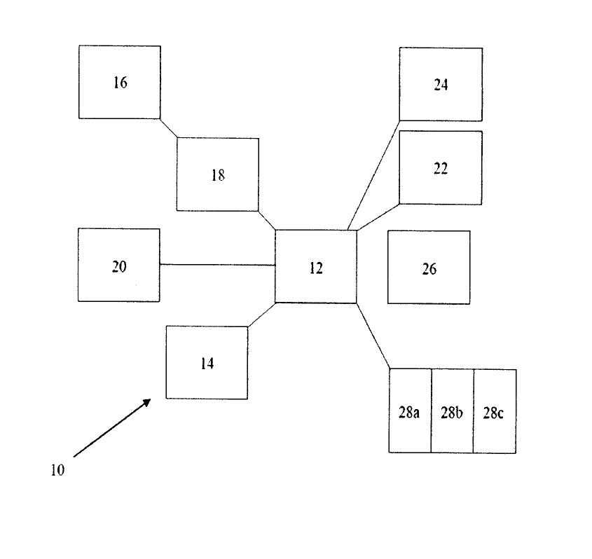

### BACKGROUND OF THE INVENTION

1. Technical Field of the Invention

The present invention relates, generally, to monitoring devices for monitoring the condition of machinery through vibration and/or temperature readings.

2. Description of the Prior Art

Machinery, especially machinery with moving parts, can, over time, develop problems during operation. This may be due to misalignment of parts, wear on parts or other issues, which may subsequently lead to further problems and failure.

Condition-based maintenance (“CBM”) and condition monitoring (“CM”) are procedures for the detection of symptoms through the measurement of one or more parameters which may be indicative of a fault condition, either by an increase or decrease in the overall measured value, or by some other change to a characteristic value, such as root-mean-square value (“r.m.s.”), peak value (“pk”), frequency component amplitude, pattern and/or distribution, etc.

Vibration monitoring (VM) is a particular technique used in condition monitoring. Vibration is the mechanical movement of a machine or asset, which may be periodic (regular) or random and contains characteristic symptoms of a wide range of machine faults, including: unbalance, misalignment, poor bearing lubrication, gear faults, motor winding and rotor faults, bearing damage, etc., and is particularly effective for monitoring rotating and reciprocating machines. Vibration monitoring utilizes vibration sensors or transducers to detect the vibration signal. The vibration signal may then be conditioned, filtered and processed using analysis instrumentation and software.

Common sources of poor vibration measurements, which limit the efficiency of CM arrangements, include poor sensor contact, faulty attachment, operator error, cable faults, ground loop, transducer fault, instrument fault, low instrument voltage and/or change of probe/magnet.

Various transducers are available for detecting vibrations in machinery and one particular system uses a portable digital assistant (PDA), which connects to a sensor device using a cable to download the information. The information can then be uploaded to a web-based server from the PDA. One of the problems with such an arrangement is that a user needs clear access to the device in order to upload information via a cable. Additionally, one not trained to interrogate the device is unlikely to identify any issues that may occur during use of the machines. Therefore, a problem may go unnoticed until a trained user is able to attend the site, interrogate the device and interpret the information collected. Furthermore, where a user needs access to the device, it may not be possible to locate the device in a position in which an efficient and effective reading may be taken, thereby limiting the use of the device.

Added to this, traditionally for accurate sampling and diagnostics to be achieved, three vibration readings are taken near each bearing in an asset; for example readings would be taken at both ends of a motor as close to the bearing as possible, each indicating different potential faults. These three readings are commonly:
1. Horizontal, where the accelerometer is in line radially with the mountings which can indicate imbalance in the machine, radial misalignment, and/or looseness;
2. Vertical perpendicular to the mountings which can indicate bearing defects or failure; and,
3. Axial, in line with the motor shaft which can indicate angular misalignment or thrust bearing problems.

Due to the number of readings potentially required on a site the time per reading can be limited affecting the accuracy of the reading and also the cost of the condition monitoring can be expensive.

AES Engineering Ltd., U.K. Patent Application No. GB 1,400,942 teaches of a device which can allow remote sensing to be possible thereby allowing effective readings to be taken. However, it is limited to taking one reading per device thereby requiring multiple remote sensors to be fitted to the asset in the orientations listed above. This means it can be costly to implement and evaluate the data reducing the thoroughness of coverage of assets on a site. Furthermore, when used remotely, due to the amount of data storage being finite (often being limited to 50 readings before downloading is required), it is necessary to compromise on either the frequency of readings taken or frequency of downloading of data. Battery life is again finite and so can also be a limiting factor as the indication means, such as light emitting diodes, can reduce the time that the device can be left on the assets before it requires removing and recharging due to the power drawn from the battery being higher. Both of these factors therefore mean that a compromise is necessary to be found between the frequency of readings, downloads or the level of visual indication and this compromise potentially reduces the quality of readings taken and increases the amount of labor and investment in devices which is required.

### SUMMARY OF THE INVENTION

Accordingly, the present invention is directed to a condition monitor that monitors vibration and/or temperatures of a piece of equipment and/or a structure, the monitor comprising:
an enclosure;
at least one vibration sensor located in the enclosure wherein vibrations are sensed about more than one axis of orientation;
at least one temperature sensor located in the enclosure;
a processor located in the enclosure and being connected to at least one of said sensors for analyzing signals produced therefrom;
means located in the enclosure for storage of the analyzed signals;
a power source connected to the processor and located in, or in close proximity, to the monitor;
means for mounting the monitor on the piece of equipment or the structure; and,
means for connecting the monitor to a secondary device, either wirelessly or with wires.

Preferably, the monitor includes means for comparing analyzed data and storing in the storage means only data readings that are statistically different to previous readings that have been taken. Statistically different may be, but need not be limited to, a percentage mean- or mode-related difference to the previous readings. The device may include means for setting the difference required to trigger the storage of data. The setting means may include an integral or remote control to alter the setting. The percentage difference may be less than, or greater than, 15%, but preferably 10%.

Preferably, the monitor includes a read or write memory chip, allowing the finite storage resource, preferably capable of storing at least 50 pieces of data, to be used most efficiently. This limitation of stored data has a number of benefits which include reducing the time it takes to download the data to a secondary device and reducing the size and power usage of the storage means. Furthermore, the increments between download to a secondary device can be increased allowing the monitoring device to be used in extremely remote locations that do not have a permanent connection to a computer network.

Preferably, the axis of orientation that the device can measure includes vibration about are horizontal and perpendicular to the mounting base and along the axis of the shaft and can be analyzed with or without simultaneous temperature readings to give a number of resultant parameters which include, but are not limited to, overall acceleration, overall velocity, peak acceleration, temperature, peak displacement, overall displacement, peak velocity and crest factor.

The monitor may include an alarm feature allowing the alarm feature to be automatically calculated based on statistical analysis of the readings collected or manually set. The calculations may make use of the historical readings for the particular application thereby allowing the alarm levels to be set specifically for the application. As a result, a lay-person may more easily interpret the readings and determine the appropriate course of action.

A power source for the device is, preferably, a battery but could also be a device that is capable of generating power from the equipment or environment or a combination of both. The benefit of this is that the battery could have an extended life, enabling the monitor continuously to take samples with no compromise on location or frequency of sampling.

Preferably, the monitor includes means for connecting it to a separate device which in turn is connected to a network wirelessly or with wires together with a number of other monitors. This could be achieved by a low energy Bluetooth® wireless connection which allows the battery life of the monitor to be optimized not requiring a compromise on the frequency of data downloads to be necessary. Accordingly, the present invention further provides a condition monitoring assembly comprising one or more monitors of the invention and, connected or connectable thereto, a separate device which in turn is connected to a network wirelessly or with wires.

The separate device may be a wall mounted device, a modem, a handheld PDA, a tablet or a smartphone, which has a separate power source to the monitor and therefore can allow transfer of power to the monitor should it be connected through a wired connection. The separate device may be wirelessly connected to a network via WiFi or 3G allowing remote use of the monitor and the separate device.

The downloading of information between the separate device and/or each monitor may be carried out automatically allowing data to be sent remotely via an application or piece of software across the network for analysis thereby reducing human interaction with the devices.

In a preferred embodiment of the present invention, data may be uploaded to the monitor remotely, via two-way wireless connectivity, allowing parameters in the sensor to be remotely configured. These parameters may include, but are not limited to, alarm levels, time frequency and duration of the periods over which vibration and temperature readings are taken and stored. Updates and amendments can be made by an authorized user logging into the monitor and making changes in a software-based control panel, which updates parameters via an internet connection, through a local wireless gateway to each sensor. Examples of where remote configuration may be used include, e.g., on machine start-up or run-down where additional readings are required for a short space of time and where the alarm levels within the sensor are clearly too high or low for the operating environment and need to be adjusted.

The monitor may be provided with visual indication means which indicate the condition of the piece of equipment via one or more light emitting diodes. Preferably, the one or more diodes are capable of indicating at least three different equipment conditions via at least three different colours, thereby allowing a lay-person to visually interpret the condition of the equipment and take the appropriate action.

The present invention also provides a method of monitoring vibration and/or temperatures of a piece of equipment and/or a structure, the method mounting a monitor of the invention on a piece of equipment or a structure, using the monitor to sense vibrations and produce signals relating thereto and analysing the signals to produce data and storing the data within the monitor.

Other objects and features of the present invention will become apparent when considered in combination with the accompanying drawing FIGURE, which illustrates a certain preferred embodiment of the present invention. It should, however, be noted that the accompanying drawing FIGURE is intended to illustrate only select preferred embodiment of the claimed invention and is not intended as a means for defining the limits and scope of the invention.

### BRIEF DESCRIPTION OF THE DRAWING FIGURE

The accompanying drawing is a diagram showing the arrangement of components in a monitor of the present invention.

### DETAILED DESCRIPTION OF THE DRAWING FIGURE AND PREFERRED EMBODIMENTS

An embodiment of the present invention will now be described, by way of example only, and with reference to the accompanying drawing:

The accompanying drawing shows a condition monitor 10 having a central processor 12 connected to a power supply 14 in the form of a battery. The device comprises a MEMs accelerometer 16, which is connected to the processor 12 via an analogue to digital converter 18. The processor 12 is also connected to an input in the form of a temperature sensor 20.

A transmitter 22 and a receiver 24 are provided and are in communication with the processor 12. The device is provided with memory 26 connected to the processor 12 and a visual indicator in the form of a plurality of LEDs 28 is also connected to the processor 12. The LEDs 28 each correspond to a particular measured or calculated parameter.

When in use, the device 12 is connected to machinery to be monitored and the MEMs sensor 16 monitors vibration levels. The received signal is passed through the analogue to digital converter 18 to the processor 12, where it can be analyzed. The processor 12 is given a default setting to provide the following information from the signal received:
vibration overall velocity amplitude (r.m.s.) derived from a power spectrum in units of mm/s;
vibration overall acceleration amplitude (r.m.s.) derived from the vibration acceleration waveform in units of g (where g=9.81 m/s²); and,
vibration peak acceleration amplitude (pk) derived from the vibration acceleration waveform in units of g (where g=9.81 m/s²).

The calculated values are then compared to predetermined limits and an appropriate level of concern attached to that value. The processor 12 then sends a signal to the visual indicators 28 according to the level of concern assigned to the parameter. For example, different colors may be displayed according to where the parameter is located on a scale; the colour displayed may vary according to whether the measurement or calculated value is below the predetermined ‘safe’ range, within range, above the range (warning) significantly above the range (alarm) and alarmingly above the range (alarm.)

The temperature sensor 20 may be provided with a visual indicator in order to indicate when the temperature of the machinery is above a predetermined threshold.

The information received by the processor 12 from the sensor 16, and any values calculated from that data, may be recorded in the memory 26, which is a non-volatile memory. The arrangement may be such that data storage only occurs when data differs from previously stored data by more than a predetermined amount. The data stored can be accessed as and when required and the data for the machinery over time can be available to a user. The data may be undeletable so that it stays with the machinery and anyone needing to review the machinery will have access to the data over the lifespan of the machinery, or at least from when the monitor 10 was installed. Where machinery fails, the memory 26 can be recovered and interrogated to provide information on the cause of the failure.

The memory 26 may be used to store a time trace, especially a vibration acceleration time trace, which allows processing of acceleration, velocity and displacement spectra. The sampling frequency and rate and the number of samples can be configured to suit the application.

The transmitter 22 and the receiver 24, which are powered by the battery 14, allow a user to communicate with the processor 12 and to access the memory 26. The user can download information from the monitor 10, or can program the processor 12 to adjust the predetermined values or to configure/reconfigure it to calculate different parameters. The transmitter 22 and receiver 24 may be in the form of a short-range radio transmission device, for example Bluetooth®, or another form of wireless transmission or wireless data exchange. Where the system forms part of a commonly used form of wireless transmission, it can send and receive information to and from a PDA, a smartphone, a laptop computer and/or a tablet. Where a wireless network is set up, the monitor 10 may be connected to that network to allow the transmission and reception of information in real time.

The device of the present invention allows for the post mortem storage of multiple dynamic and static measurements, full waveform (time trace) storage for vibration measurements, ISO vibration alarms and configurable alarm sets, frequency ranges (for example, 2 to 250 Hz, 2 to 1000 Hz or 10 to 1000 Hz), and a unique sensor ID (GUID).

The sensor device may be an integrated electronics piezo-electric accelerometer (IEPE).

An audible alarm system and/or an automatic signal transmission program may be incorporated into the device and, where the measured parameter and/or calculated value is above a particular pre-set level, the device may issue an alert.

A plurality of sensors may be incorporated into the device in order to calculate or measure more than one parameter. Further indicators (visual or otherwise) may be provided to show whether the machinery is operating as expected.

The units in which the data is recorded, and the calculated parameters, can be adjusted according to the user's requirements using the transmitter and receiver to program the processor.

The present invention integrates a CF2 A-D card and an IEPE transducer power interface board into a combined A-D and IEPE power board. This also includes a Bluetooth® interface to the PDA, thus obviating the requirement for a cable and plug PDA data connection.

In a further embodiment of the present invention, the battery of the above-described condition monitor is replaced or supplemented by means for connecting the monitor to a mains power supply.

While only several embodiments of the present invention have been shown and described, it will be obvious to those skilled in the art that many modifications may be made to the present invention without departing from the spirit and scope thereof.

What is claimed is:

1. A condition monitor for monitoring at least one of vibration and temperature of a piece of equipment, comprising:
an enclosure;
at least one vibration sensor located in said enclosure for sensing vibrations about more than one axis of orientation;
at least one temperature sensor located in said enclosure;
a processor located in said enclosure and connected to at least one of said vibration sensor and said temperature sensor for analyzing signals produced therefrom; and,
means for storing the analyzed signals.

2. The condition monitor for monitoring at least one of vibration and temperature of a piece of equipment according to claim 1, further comprising means for comparing analyzed signals as analyzed data and storing in said means for storing only statistically differing data readings.

3. The condition monitor for monitoring at least one of vibration and temperature of a piece of equipment according to claim 2, wherein said statistically differing data readings are percentage mean- or mode-related differences as compared to previous readings.

4. The condition monitor for monitoring at least one of vibration and temperature of a piece of equipment according to claim 3, wherein said percentage mean- or mode-related differences is at least 15%.

5. The condition monitor for monitoring at least one of vibration and temperature of a piece of equipment according to claim 3, wherein said percentage mean- or mode-related differences is at least 10%.

6. The condition monitor for monitoring at least one of vibration and temperature of a piece of equipment according to claim 3, further comprising means for setting statistically differing data readings as compared to the previous readings that will result in storing only statistically differing data readings.

7. The condition monitor for monitoring at least one of vibration and temperature of a piece of equipment according to claim 1, wherein said more than one axis of orientation for sensing vibration by said at least one vibration sensor are two or more axes horizontal and perpendicular to a mounting base and co-axial with a longitudinal axis of a shaft of the piece of equipment.

8. The condition monitor for monitoring at least one of vibration and temperature of a piece of equipment according to claim 1, further comprising means for mounting said condition monitor on a piece of equipment.

9. The condition monitor for monitoring at least one of vibration and temperature of a piece of equipment according to claim 1, wherein said processor processes both vibration signals and temperature signals for calculating parameters from said processor for simultaneous recordation.

10. The condition monitor for monitoring at least one of vibration and temperature of a piece of equipment according to claim 9, wherein the parameters include at least one of overall acceleration, overall velocity, peak acceleration, temperature, peak displacement, overall displacement, peak velocity and crest factor.

11. The condition monitor for monitoring at least one of vibration and temperature of a piece of equipment according to claim 1, further comprising an alarm for alerting a user to preset statistical analyses for triggering said alarm.

12. The condition monitor for monitoring at least one of vibration and temperature of a piece of equipment according to claim 11, further comprising means for automatically calculating the preset statistical analyses for triggering said alarm.

13. The condition monitor for monitoring at least one of vibration and temperature of a piece of equipment according to claim 1, further comprising means for automatically downloading data via a software application to a remote network.

14. The condition monitor for monitoring at least one of vibration and temperature of a piece of equipment according to claim 1, further comprising visual indication means for indicating condition of the piece of equipment via at least one light emitting diode.

15. The condition monitor for monitoring at least one of vibration and temperature of a piece of equipment according to claim 14, wherein said at least one light emitting diode is capable of indicating at least three different equipment conditions via at least three different colors.

16. A method for determining condition of a piece of equipment based upon at least one of vibration and temperature, comprising the steps of:
monitoring a piece of equipment using at least one vibration sensor for producing vibration signals and at least one temperature sensor for producing temperature signals; and,
analyzing at least one of said vibration signals and said temperature signals.
